(19) United States
(12) Patent Application Publication
(10) Pub. No.: US 2010/0131562 A1
(43) Pub. Date: May 27, 2010

(54) METHOD OF DYNAMICALLY MANAGING AND SHARING DATABASES IN A MOBILE COMMUNICATION TERMINAL AND A MOBILE COMMUNICATION SERVER SYSTEM

(75) Inventors: Jin Ah EOM, Daegu (KR); Jong Eun YOON, Daegu (KR); Il Hee LEE, Daegu (KR); Hyun Chul SHIN, Busan (KR)

Correspondence Address: ROBERTS MLOTKOWSKI SAFRAN & COLE, P.C.;Intellectual Property Department, P.O. Box 10064, MCLEAN, VA, 22102-8064, US

(73) Assignee: FUSIONSOFT CO., LTD., Daegu-si (KR)

(21) Appl. No.: 12/324,216

(22) Filed: Nov. 26, 2008

(51) Int. Cl. G06F 17/30; G06F 12/00; G06F 3/048

(52) U.S. Cl. 707/793; 715/764; 707/E17.032; 711/E12.001

(57) ABSTRACT

A method of dynamically managing and sharing database in a mobile communication terminal and a server system is provided. By installing applications such as a database system and a user interface programs in the mobile communication terminal, a user forms a database arbitrarily in a form of his/her own preference, input data there, and forms a user interface in a form of their preference. Also, the data managed in the mobile communication terminal may be stored and managed in a mobile communication server system through a wireless network or in a computer through a wired network. The user can download database template a provider provides to the mobile communication terminal from the mobile communication server, use them without generating the database structure for him/herself, and graphs and numerical expressions the user produced using the data of database may be included. Also, the template may be set with sharing right and using right, such that the user can use the template only within the allowed scope of sharing and using.

### FIELD OF INVENTION

The invention relates to a method of managing data in a mobile communication terminal, and more particularly to a method, in which a user of the mobile communication terminal generates a database and manages the data according to a type desired by the user, cooperates with a web server or computer to share the database, and synchronizes with them.

### BACKGROUND OF INVENTION

In recent trends, a mobile communication terminal is not just a means for phone calls, but it is expanding its applications wider and wider, including a tool having a personal information managing function as in the above. Especially, a user of a mobile communication terminal wants to store necessary information or material in a database of one's own desirable structure and then manage. For example, a personal computer has been used to manage materials for automobile maintenance ledge, shopping list manager, customer manager, grade manager. However, the users want to perform such tasks on a mobile communication terminal using features such as portability and instant inquiry of the mobile communication terminal. Also, the users want to open a database, provided by one's own computer or a web server, on one's own a mobile communication terminal, and use it with or without changing in one's desirable structure. In addition, they want to back up the database made in the mobile communication terminal in a web server or a personal computer.

### SUMMARY OF THE INVENTION

However, the mobile communication terminals do not provide a function for the user to generate a database of a user's desirable style for him/herself. For example, in an application of phone directory, since the manufacturer provides in a fixed form, the user cannot change its data structure arbitrarily. That is, the concept of managing material using the mobile communication terminal in prior arts was not the user's generating actively a database, but using passively the data structure that the manufacturer provided. Therefore, since it was not possible to use a data structure which the manufacturer did not provide, it was very limited to use a mobile communication terminal as a means for personal information manager.

In order to make it useful for a personal information managing means, many recently introduced mobile communication terminals are equipped with a database managing system and an enlarged screen. However, even in such mobile communication terminal, it is limited to ‘using a given database only’, and the user cannot generate the database of one's own structure for him/herself.

Considering the convenience of usage, it is desirable to allow the database generated and managed everywhere including a mobile communication terminal, computer, or a web server, and to share the database compatibly among them.

A mobile communication terminal has much lower capacity to store data compared to the environments of a web server or a personal computer. This aspect needs to be considered specially in sharing the database in the web server or the personal computer.

Also, due to the amount of pouring-in information, the user wants to obtain necessary information in an individually customized form. General applications used in most of the mobile communication terminals provide a fixed user interface. In such applications, the user cannot change the user interface in one's own desirable form to manipulate the data arbitrarily. Users become more and more capable to use a high level of information managing technique, and generate for him/herself user contents of a level which was unthinkable before. Thus, such users need an environment in which a database of a desirable from can be made and inputted with data, and furthermore the user can manage the data in the database through the user interface that the user formed.

The invention is to solve the above problems, and the goals of the invention is to provide a method, in which a user can generate a database of one's own desirable structure for him/herself and simply and manage the data through the database dynamically, and the user can form one's own user interface.

Also, the present invention is to provide a method for using a database generated by a mobile communication terminal or a database downloaded from a web server or a personal computer in a linked form by sharing and synchronizing.

According to an aspect of the invention to achieve the above goals, a method of dynamically managing databases in a mobile communication terminal is provided, in which the method comprises: a first step of providing a user input screen to allow a user to generate a database of the user's own desirable structure in the mobile communication terminal, generating a dynamic database structure based on database generation information inputted by the user through the input screen, and storing the generated database structure and the database generation information inputted by the user in a first storing means of the mobile communication terminal, on the user's request; a second step of providing an editing screen for editing a structure of a database which the user selects out of the databases stored in the first storing means, and changing the structure of the database stored in the first storing means and the database generation information based on editing operation that the user performs on the editing screen, on the user's request; and a third step of, if the users upload the database templates written in advance by the users onto a mobile communication server system through a communication network using a mobile communication terminal or a personal computer, the mobile communication server system's receiving the uploaded database template, storing in a second storing means in the mobile communication server system, and registering it as a sharable database template, wherein the database template comprises a file including a name of the database generated with a pre-designed structure and information on the database such as data stored following the data structure of the database, or a file further including some additional data, and wherein the database template is set with at least one of a sharing right and a using right.

The method of dynamically managing the database further comprises a step of providing a screen forming tool for forming a desirable user screen in order to enable the user to select and observe data of a specific database in the first storing means or the second storing means in a desirable form, and storing a specific meta data on the user screen that the user formed as the additional data in the specific database.

Here, the database template desirably further comprises meta data on the user screen including a name of the user screen and a selected column list. Also, the specific meta data on the user screen preferably comprises the name of the user screen and the column list that the user selected for displaying on the user screen, and each of the column information of the column list preferably comprises a column title, a style of column data that the user inputs, a column position information (that is, order of display on the screen for each field), and a field ID corresponding to the column.

Furthermore, the specific meta data on the user screen may comprise information on graphs and/or equations formed by using data of corresponding database.

It is preferable to provide a structure allowing a contents provider to insert other contents such as an advertisement as well as the contents the user inputted in the database template, such that the database template can be used as a more practical database. For this purpose, the database template may comprise a meta data on the advertisement such as a separate table or column for inserting the advertisement thereinto. Here, a meta data information on the user interface that the user formed for him/herself may be added to the database or the database template, such that each user can look up the information in one's own desirable form.

In the method of dynamic managing of database, the sharing right comprises information specifying a number of sharable users and/or the users for whom sharing is allowed for the database template. Also, preferably the using right comprises information specifying at least one among an allowed using action, an allowed editing scope, an allowed sharing scope, and an allowed copying scope for the database template.

Also, in the method of dynamic managing of database, the database generation information which is inputted by the user in the first step comprises information on a name of database, a number of fields of the database, a name of the field, and a data type of each field.

The method of dynamic managing of database may further comprise a step of the mobile communication server system's providing list of the database template stored in the second storing means to the mobile communication terminal on request from the user of the mobile communication terminal, and, if the information of database template which the user selected is received from the mobile communication terminal, reading out the selected database template from the second storing means and transmitting to the mobile communication terminal of the user.

It is preferable that the shared database may be used in a mobile communication terminal of different types irrespective of platform characteristics of the mobile communication terminal. Since the shared database is downloaded to the mobile communication terminal as a form of database template, a dependency on the platform may be avoided by including in the database template only the data which is free from characteristics of platform of the mobile communication terminal.

The method of dynamic managing of database may further comprise a step of the mobile communication server system's maintaining the database list by the users, displaying on the web the contents of the database for a specific database which the user wants to look up or edit, and updating the specific database with the updated contents. The database list comprises information on names of all databases that the user owns, times of generation of database, times of synchronization, and number of owned data.

The method of dynamic managing of database may further comprise steps of: if the user requests synchronizing of a specific database stored in the first storing means, the mobile communication terminal's finding out a database for synchronizing that the user requested in the first storing means, delivering information for synchronizing to the mobile communication server system through a wireless communication network, and requesting synchronizing of the requested database; and on answering the synchronization request of the mobile communication terminal, if the corresponding database does not exist in the second storing means, the mobile communication server system's generating the synchronization-requested database newly, and if the corresponding database exists in the second storing means, and updating the corresponding database into the synchronization-requested database to perform synchronizing such that the synchronization-requested database coexists with same contents in the mobile communication terminal and the mobile communication server system.

In the method of dynamic managing of database, the information for synchronizing comprises a synchronization request message including a users ID and password of a user registered in the mobile communication server system, a database information for checking whether there is a difference between the databases of the mobile communication terminal and the mobile communication server system, and a synchronizing time used for synchronizing and a maximum message size information for transmitting.

Also, the synchronizing process performs synchronizing, based on analysis of the synchronization request message, i) in a way of exchanging all the data of the synchronization-requested database if the database has never been synchronized after data generation in the mobile communication terminal, ii) in another way of exchanging only the data which was updated in the synchronizing process if the database has been synchronized at least once.

According to the present invention, a shortage of data managing application for mobile communication terminal that the user wants to use may be solved. The users can make a form of database in a way following their tastes within a short period on a mobile communication terminal, a web, or a computer, and store data according to the form. For example, the user can form data of any format including automobile maintenance ledge, shopping list, customer manager, news, etc., and sort out, search, and manipulate the data. Especially, by applying the database to the mobile communication terminal, a remarkable processing speed increase and shortening of development period of application compared to applications in prior arts such as a phonebook.

Also, the users can realize a blog made into a database of one's own and a data managing system conveniently in the mobile communication terminal, and defines lists of one's desirable type and use the database following the type. And, it is possible to back up the generated database contents through communication remotely anytime, so as to prevent a danger of data loss. Also, it enables managing data efficiently in many cellular phones which have a lot of limitations in memory and user interface. In addition, it is possible to use and manage the data anywhere anytime, not hindered by mobility.

Furthermore, since it is possible to manage data in a personal home computer connected by a personal computer link, a communication cost can be conserved. Additionally, when it is troublesome for the user to generate the database for him/herself, a customized template defined already in the server system can be obtained and used, such that the user gets freed from a burden of generating database for him/herself.

### BRIEF DESCRIPTION OF DRAWINGS

FIG. 1 is a schematic diagram of a system for a method of dynamically managing data according to an embodiment of the invention;

FIG. 2 is a block diagram illustrating software elements necessary for enabling a method of dynamically managing data in a mobile communication terminal according to an embodiment of the invention;

FIG. 3 is a block diagram illustrating a detailed structure of a mobile communication server system (30) for enabling an embodiment of the invention;

FIGS. 4 and 5 are a flowchart and a block diagram illustrating procedures for a user to generate a database called ‘grade manager’ and elements of a screen of mobile communication terminal which a user interface provides, respectively;

FIG. 6 is a diagram illustrating a database for a grade manager which a user generated in a mobile communication terminal;

FIG. 7 is a diagram illustrating a list of database stored in a mobile communication terminal;

FIG. 8 is a diagram illustrating a screen of mobile communication terminal with a database contents ‘My Restaurants’ displayed;

FIG. 9 is a flowchart illustrating flow between a template and a user data in a service provided on a web server;

FIG. 10 is a diagram illustrating a signal processing chart showing a synchronization process between a synchronization server of mobile communication server system and a mobile communication terminal;

FIG. 11 is a diagram illustrating a structure of a synchronization message;

FIGS. 12 and 13 are a flowchart for a user's generating a user interface form called ‘Average Form’ and a diagram of a screen, in which the user generates a user-forming screen by selecting a column of a database that the user generated on a mobile communication terminal provided by a user interface, respectively.

### DETAILED DESCRIPTION OF THE INVENTION

The present invention is going to be described in detail referring to the drawings below.

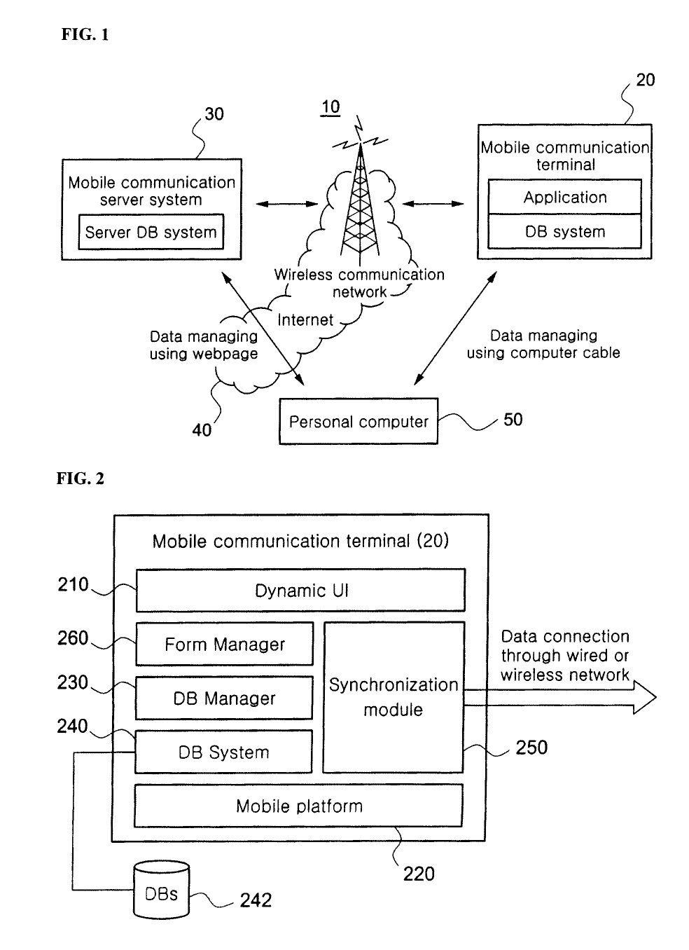

The system (10) of FIG. 1 is a system for enabling a method of dynamically managing data according to an embodiment of the invention. The system may comprises an application which can handle the method of dynamically managing data on a mobile communication terminal, a database system associated with the application, a mobile communication server system providing data which the user needs, and an application for backing up the data in a computer. In an aspect of hardware, the system further comprises a mobile communication terminal (20) including hand-held phone or smart phone, PDA, PMP, etc., a mobile communication server system (30), and a communication network (40) for connecting them for communication. The system (10) also may further comprise a personal computer (50) of the user. The mobile communication terminal (20) is able to communicate with the mobile communication server system (30) through a wireless network (40), and with the personal computer (50) through a computer communication cable such as USB cable. A data sharing and maintenance between the personal computer (50) and the mobile communication server system (30) may be achieved through a webpage.

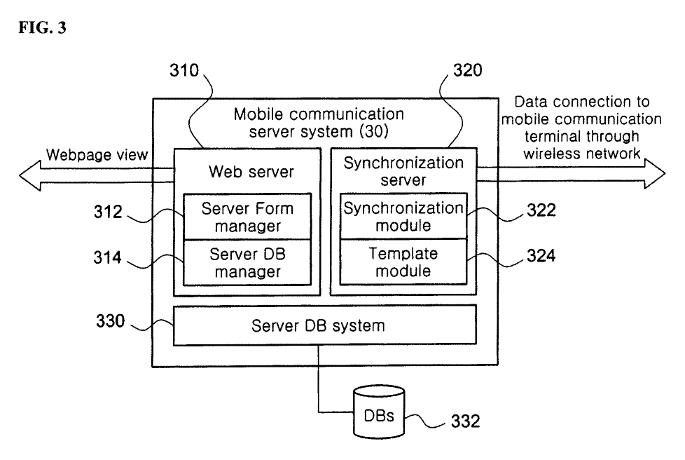

As for hardware, the mobile communication terminal for using in the present invention may be a regular mobile communication terminal having resources such as a CPU, a memory, a key input device, a display, etc. As for software, however, there are elements that should be installed for the invention. FIG. 2 shows a block diagram illustrating software elements necessary for enabling a method of dynamically managing data in a mobile communication terminal according to an embodiment of the invention. Programs installed in the mobile communication terminal (20) for enabling the present invention may comprise a dynamic user interface (210), a form manager (260), a database manager (230), a database system (240), a mobile platform (220), a synchronization modules (250), etc. These programs may be stored in a storing means such as an internal memory of the mobile communication terminal (20). Also, databases which are generated or managed by the database system (240) may be stored in such a storing means (not shown).

The user interface (210) installed in the mobile communication terminal (20) is a mobile platform-based program provided by overcoming a shortcoming of a small screen of the mobile communication terminal, and a module for connecting input and output between the user and the database system (240). This user interface (210) generates dynamically the user interface according to the property of data which the user uses. Also, in generating database, it enables the user to select and assign the data type of database for him/herself. By this, the user can determine the property of the database for him/herself. The supportable data types comprise multimedia data such as video, picture, audio, etc. as well as text data such as integer, character string, date, time, true-false selection, list, etc. In addition to generating database, the user interface (210) also deals with inputting, manipulating, and maintaining of data of database, and it handles a design for displaying the data on the screen of the terminal. For example, in case of the character string type data (e.g., name, contents, detailed information, sentence, etc.), it enables a long sentence input and makes the input checkable on the screen. As for the integer type data (e.g., grade, price, various numerical information, etc.), it may be shown on inputting and enabled for numerical operations. The date type data (e.g., 2006/03/26) must be possible to input the data in a format suitable to the style of year/month/day, and the time type data (e.g., 13:56:27) must be possible to input the data in a format suitable to the style of hour/minute/second. Also, as for the list type data, it must be possible to select one from predetermined character strings, which was determined in advance by the user. The user interface (210) must support such functions.

The form manager (210) manages a form which is a separate user-generated interface in order to allow the user to manage the database. The user should be able to select a specific column of the database that the user generated and look up necessary information, or to make forms by adding numerical expressions or equations, graphs, etc. The form information generated in the form manager (210) is also stored in the database (242), and the stored form information is delivered to the dynamic user interface (210), so as to make a user interface in a form which the user made. The user can select the same data expression type through the form manager (210). For example, it is possible to make the form to represent a type of 2008-11-19 with a similar date type such as 2008.11.19. And, when the test scores or grades for Korean, English, etc. are stored monthly, an average, a sum, a maximum, a minimum of the test scores are allowed to be used using numerical expressions. Also, it may support graphs, such that the stored database can be shown in a type of graph. The information needed for the forms including a name, selected column, column name, column type, equation, graph form name, graph data region, etc. is stored in the database (242).

The database manager (230) deals with data transfer between a mobile platform (220), which will be described later, and the database system (240). Execution of various data manipulation commands (for example, search, sorting, calculation, etc.) is commanded through this database manager (230).

The database manager (240) is responsible for generating and managing database (24) in a storing means of the mobile communication terminal (20). This generates a database structure of a type which the user defined in response to a database generation request delivered from the user interface (20). Also, for the database that the user assigned, various types of data delivered from the user interface (210) are inputted the corresponding database along with the type information, stored, and managed systematically, and the data requested by the database manager (230) are read from the database (242) and provided to it. Usable data types provided in the database system (240) are able to be connected in the user interface (210).

The mobile platform (220) is an element provided basically in the mobile communication terminal (20), and manages all of the user interfaces of internal systems, so as to operate coded user interface (210). The data input from the user interface (210) are delivered to the database system (240) through the mobile platform (220). Commercially available mobile platforms such as BREW, WIPI, GVM, etc. may be the mobile platform (220) applied in the present invention.

Since the mobile communication terminal (20) does not have enough memory resource, it has a limitation to manage large amount of data. Therefore, it may be efficient to synchronize and back up the database (242) in a server database of the mobile communication server system (30) and call up to use whenever they are needed. In order to manage database in such ways, the synchronization module (250) supports communication with external resources such as the mobile communication server system (30) or the personal computer (50), enabling synchronization among databases (242, 332) that are stored in the mobile communication terminal (20), the mobile communication server system (30), or the personal computer (50). The synchronization module (250) comprises communication protocols for communicating with various external devices through wired or wireless communication, and provides a data information exchanging function with external devices of the mobile communication terminal (20). Through this synchronization module (250), it is possible to upload the databases (242) generated in the mobile communication terminal (20) to the mobile communication server system (30) through a communication network (40) such as wireless network, or download templates which the mobile communication server system (30) provided or database (332) backed up there to the mobile communication terminal (20). Also, it is supported to download and upload data managed in the mobile communication terminal (20) to the personal computer (50). Through this, the user can handle the data conveniently even in the personal computer (50).

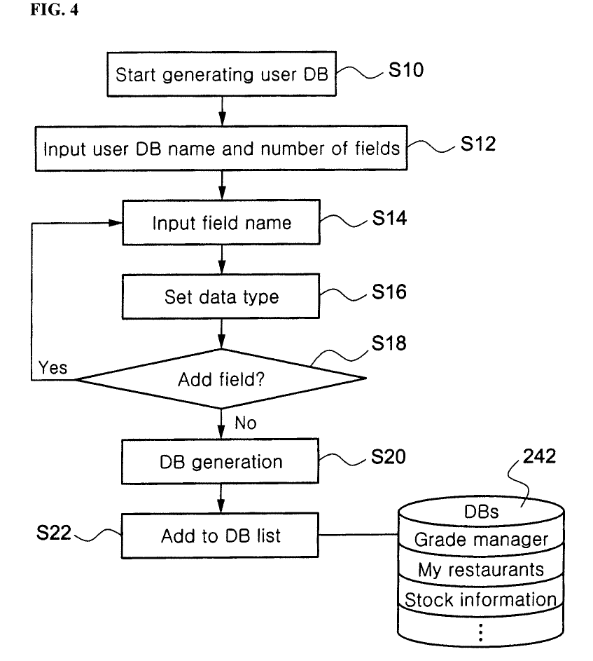

FIG. 3 shows a block diagram illustrating a detailed structure of a mobile communication server system (30) for enabling an embodiment of the invention. The mobile communication server system (30) stores and manages database provided by the mobile communication terminal (20), and sometimes provides a stored database on request from the mobile communication terminal (20). Also, it stores various templates, and provides them to the mobile communication terminal (20) or a personal computer (50) on the user's request. In order to support these functions, the mobile communication server system (30) may comprise a web server (310), a synchronization server (320), and a server database system (330). It is preferable for the server database system (330) to adopt a stable database system which can manage a large amount of data. The databases (332) managed by the server database system (330) may be stored and managed in a storing means (not shown) such as a hard disk in the mobile communication server system (30).

The mobile communication server system (30) also provides a function for managing the contents through the Internet in connection with the personal computer (50). That is, by downloading and uploading data to the computer (50) through a webpage, the data can be managed through the personal computer (50), so as to be able to manage data irrespective of location and time. For this, the web server (310) needs a server installation program for executing a role of a regular web server, and express various situations by forming a webpage with languages such as PHP, ASP, JSP, etc. through the server installation programs. In the web server (310), through the webpage, one can use the functions for managing form and database in the terminal using a server form manager (312) and a server database manager (314) which are similar to the mobile communication terminal (20).

A synchronization module (322) is installed in the synchronization server (320). The synchronization module (322) is a synchronization module in the server side, corresponding to the synchronization module (250) of the mobile communication terminal (20). This server-side synchronization module (322) cooperates with the mobile communication terminal (20) side synchronization module (250) to provide a function of maintaining synchronization between two databases (242, 332) of the server database system (330) and the database system (240) of the mobile communication terminal (20). The personal computer (50) is also synchronized with the database (242) of the database system (240) through the synchronization server (320). The synchronization among them is achieved through the webpage provided by the web server (310). That is, the web server (310) shares the database (332) of the database system (330) with the synchronization module (320), and at the same time using the shared database (332), generates a webpage and provides it to the personal computer (50) accessing through communication network (40) such as Internet. Also, on the contrary, the personal computer (50) provides data delivered by a webpage provided by the web server (310) or own files to the server database system (330). By this, the data stored in the database (332) of the mobile communication server system (30) and the personal computer (50) is synchronized.

It is desirable to make the shared database usable in mobile communication terminal of different model irrespective of platform characteristics of the mobile communication terminal. The shared database is downloaded to the mobile communication terminal in a form of database template. In order to make the shared database usable in different terminals, when making a database template, only the data which is not related to the platform characteristics is included in the template. But, providing screen using it needs to be embodied according to each platform.

The synchronization module (320) also comprises a template module (324). The template module (324) is a program providing a function for generating and registering various database templates which a server administrator or web users can use in the mobile communication terminal (20) or the personal computer (50). This template module (324) also provides templates stored in a server DB system (330) to the mobile communication terminal (20) or the personal computer (50) in response to the user's request. A template is a database file made to have a pre-designed structure or the database file with some associated data.

The mobile communication server system (30) having the above structure enables to synchronize the user-owned data and the database (332) in which the templates are stored with the mobile communication terminal (20) through the synchronization server (320). That is, the user can use data and template more efficiently using the method of dynamically managing data in an environment where the mobile communication server system (30) and the mobile communication terminal (30) are connected.

Also, the mobile communication server system (30) allows some users to share templates which other users prepared in advance for an efficient data managing or database template which other users uploaded. If the server administrator or users makes templates including contents and then uploads through the web server (310), they are registered to the database (332) by the server DB system (330). The users accessing through the communication network (40) can look up the various templates registered in the database (332). The database is downloaded along when the related template is downloaded to the mobile communication terminal, and shared.

It is preferable to be able to set a sharing right for a database template uploaded for sharing. The sharing right may include contents for specifying, for example, a number of users for whom the sharing is allowed and/or sharing-permitted people. Also, it is preferable to be able to set a using right for a database template uploaded to the mobile communication server system (30). The using right may include contents specifying allowed usage action, allowed editing scope, allowed sharing scope, or allowed copying scope for the database template. The users can download a template they want to the personal computer (50) or the mobile communication terminal (20) within the sharing scope and/or the using scope allowed to them and use as it is, or change according to their need and then use it. Changing a downloaded template is allowed as long as the editing right is given to other users, and it is achieved by adding or deleting the DB field using the editing functions provided by the user interface (210). If the user interface with such functions is adapted for and installed in the web server (310) or the personal computer (50), the user can change the template even in a webpage provided by the web server (310) or in the personal computer (50) if needed.

In order to enable to use as a more practical database template, it is preferable for the database template to enable a third party such as a contents provider or an advertiser to insert there other contents such as an advertisement, for example, as well as the contents the user inputted. For this, it is necessary that the database template has a flexible structure enabling to add or insert contents afterwards. For inserting an advertisement data, in addition to the tables and columns which the user made, other tables or columns for the advertisements are added to the database template. Also, a separate contents (advertisement) input screen may be provided to those who want to insert advertisement, for example, an advertiser or a contents provider. If the advertiser or the contents provider inserts an advertisement in the tables or columns provided for advertisements using the contents input screen, the system stores meta data on the advertisement data input as supplementary data along with the database template. Through this, the advertisement is delivered as one combined with the template.

For efficient use on a webpage provided by the web server (310) of the mobile communication server system (30), each of the users must be allowed to keep the list of their own databases. The database list includes information on names, time of generation, time of synchronization, number of data, etc. for all the databases the user owns. When the user wants to perform editing such as view, update, delete, etc. on a specific database, the contents of the database is configured to be displayed on the web. Also, the contents of database are configured to be updated as edited by the user. At the time, the user's database cannot predict a number of fields, a number of records, and a length of data. Therefore, the webpage cannot exist as a predetermined form, and the data information the user generated is read from the database and shown by dynamically generating a webpage according to the form.

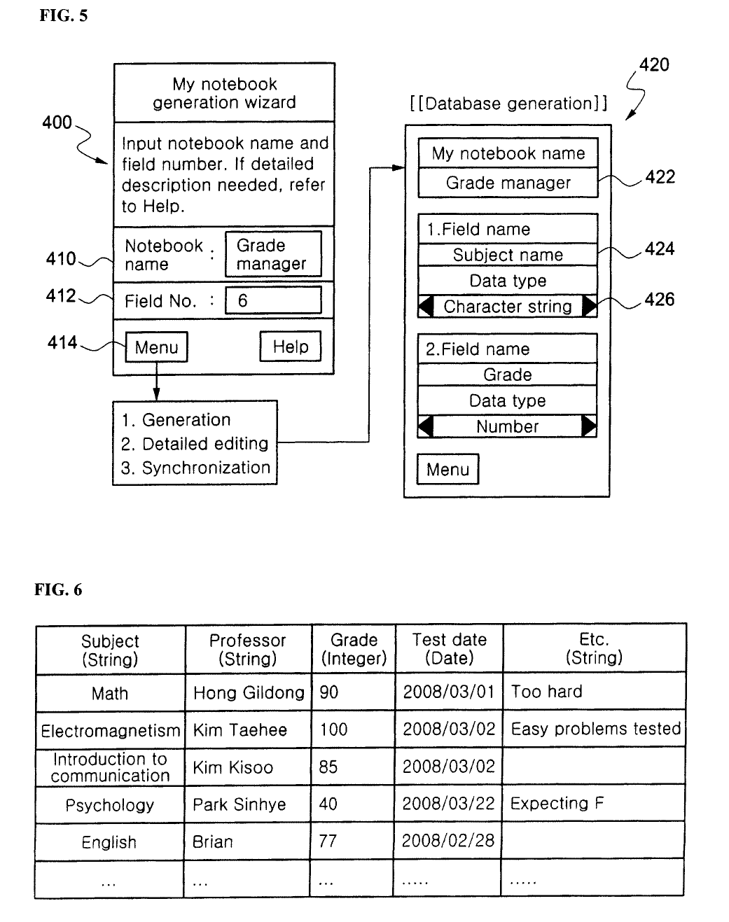

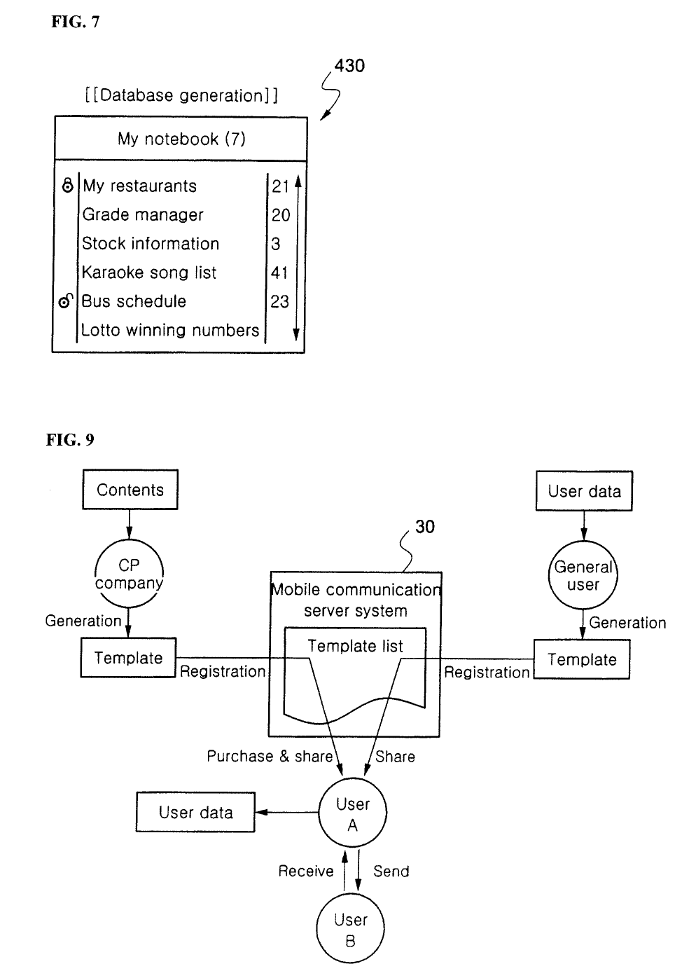

The user can generate a database using his/her own mobile communication terminal (20) conveniently. FIGS. 4 and 5 are a flowchart and a block diagram illustrating procedures for a user to generate a database called ‘grade manager’ and elements of a screen of mobile communication terminal which a user interface provides, respectively. If implementing a DB generation function in a mobile communication terminal (20) (step S10), a screen (‘My Notebook’ generation wizard) such as 400 of FIG. 5 is displayed. In this screen, a DB name ‘Grade Manager’ and a number of fields ‘6’ are inputted in the notebook name (410) and the number of field (412) (step S12). Then, the grade manager DB is generated by pushing a menu button (414). The menu button (414) provides two types of DB generation functions. A button ‘1. Generation’ in the menu button (414) generates the field name and the data types of each field in a basic form (for example, providing data types for all fields with a character string, the default value), while ‘2. Detailed Editing’ enables the user to edit the name of field and the data type of each field in a form the user wants as shown in the right side of FIG. 5. The user sets the name (424) and the data type (426) of each field in the editing screen (420) (steps S14, S16). For instance, the grade manager database assigns data types of field name, character, number, data, and character such as ‘Subject’, ‘Score’, ‘Test date’, ‘Comments’ in order to the four fields. Using this style, the name and the data types of all fields are set, and if there are no more fields to add, a grade manager database is generated and added to the database list (steps S18, S20, S22). The databases generated this way are registered as databases (242) that the database system (240) of the mobile communication terminal (20) manages. A field of a character type can have a various data length. Such a database generation is enabled on the web server (30) or a personal computer (50) as well as in the mobile communication terminal (20). FIG. 6 is a diagram illustrating a grade manager database which the user generated in such a style.

The user interface (210) provides various functions showing the list of databases (242) the database system (240) of the mobile communication terminal (20) maintains and contents of a specific database the user selected, and functions providing convenience in editing such as adding or deleting fields on an existing database and data updating, and searching for a wanted data or sorting. In the data search provided by the user interface (210) of the mobile communication terminal (20), it is possible to perform Korean sentence search or Korean category search in a terminal supporting Korean, and it is possible to perform English sentence search in a terminal supporting English. Also, in an integer type search, it is possible to perform a search in a style of maximum and minimum, and a search for contents with same value only with character input such as a character string. FIG. 7 is a diagram illustrating a list of database stored in a mobile communication terminal. As shown, the databases (my notebook) registered presently are seven including ‘My Restaurants’, ‘Grade Manager’, etc., and the number of records registered on the ‘My Restaurants’ and ‘Grade Manager’ databases are 21 and 20, respectively.

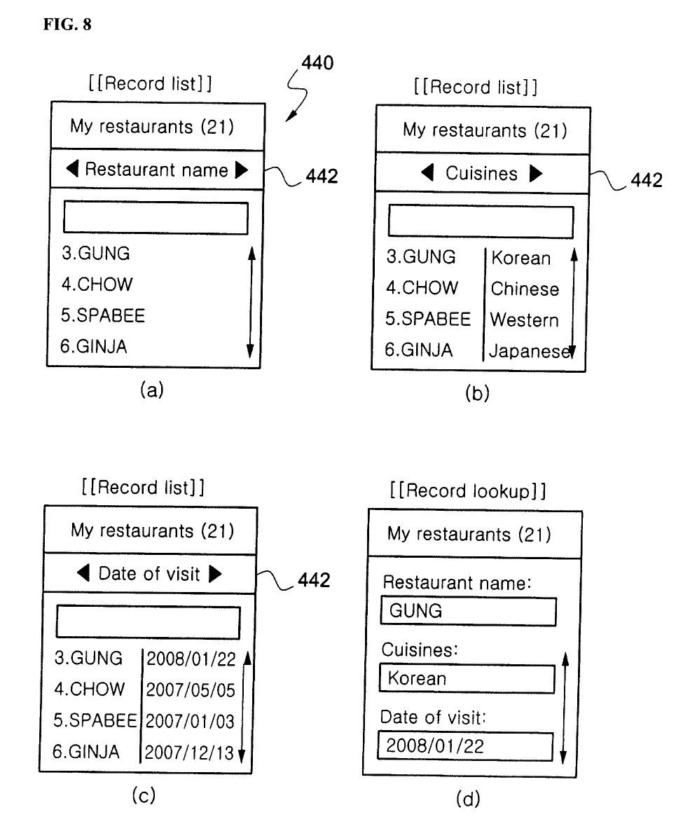

If the user selects ‘My Restaurants’ from the list of FIG. 7, the user interface (210) delivers the information to the database system (240), receives the ‘My Restaurants’ database registered in the database (242), and displays them on the screen. FIG. 8 is a diagram illustrating a screen of mobile communication terminal with a database contents ‘My Restaurants’ displayed. The contents of the database may be represented according to each field. As shown in FIGS. 8(a)-(c), in case of setting the fields (442) of the ‘My Restaurants’ database screen (440) as ‘Restaurant name’, ‘Cuisines’, and ‘date of visit’, respectively, the information such as ‘Restaurant name’ list, cuisine list, date of visit, etc., which are registered in the ‘My Restaurants’ database, are displayed on the screen. Also, if a specific restaurant is selected in the FIG. 8(a), the entire contents on the selected restaurant are displayed.

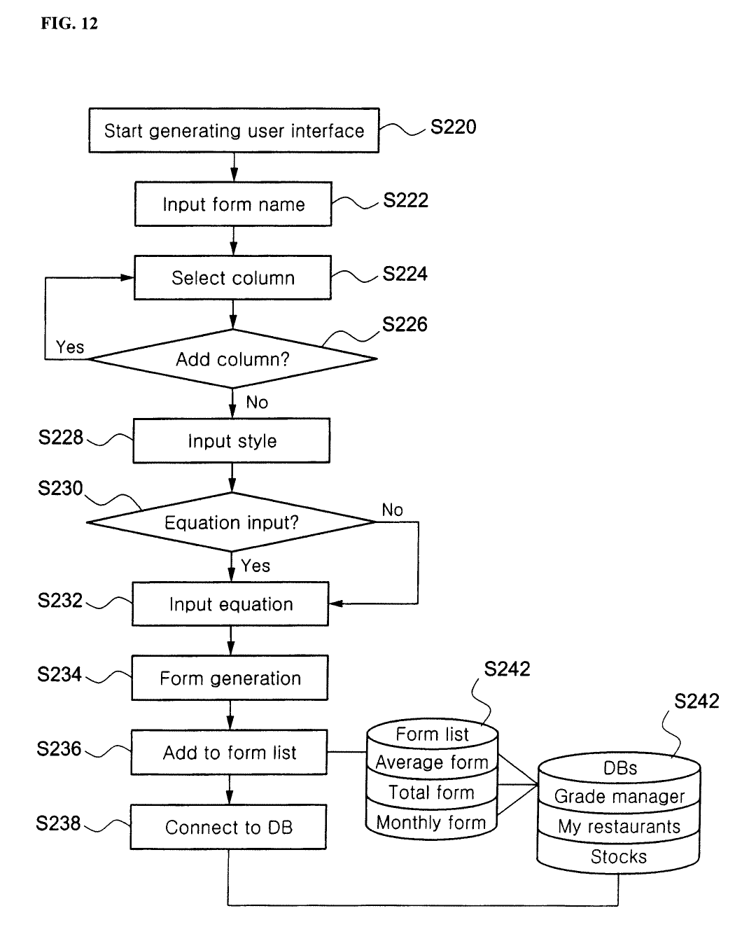

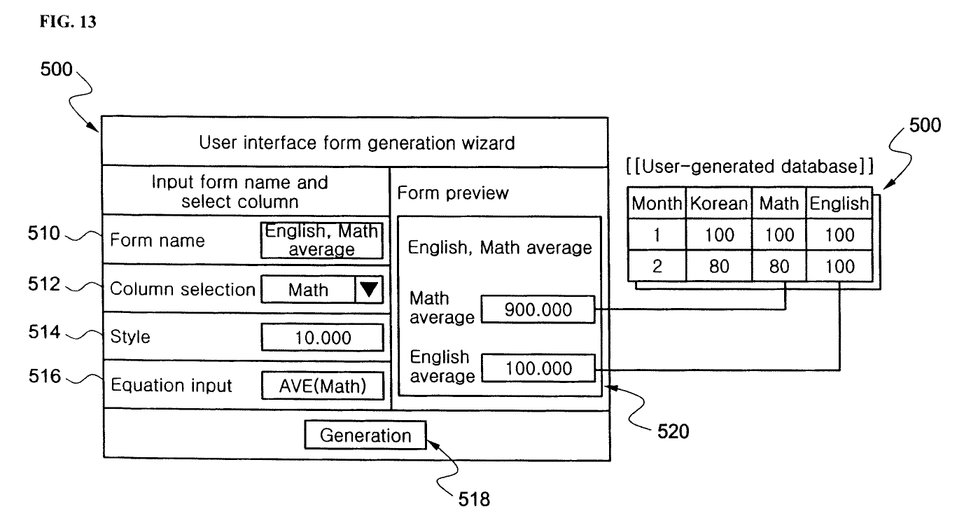

The users can generate a user interface form they wants conveniently using their own mobile communication terminal (20). FIGS. 12 and 13 show an exemplary flowchart for a user's generating a user interface form called ‘Average Form’ and an exemplary diagram of a screen, in which the user generates a user-forming screen by selecting a column of a database that the user generated on a mobile communication terminal provided by a user interface, respectively. If the user executes a user interface form generation function in the mobile communication terminal (20) (step S220), a screen (a user interface form generation wizard) such as 500 in FIG. 13 is displayed. The user interface form generation wizard (500) is a ‘Screen forming tool’ provided in the mobile communication terminal and/or mobile communication server system allowing the user to look up data of a specific database stored in a storing means of the mobile communication terminal or mobile communication server system in a form the user wants. The user interface form generation wizard (500) provides functions allowing the user to look up a structure information of database the user generated already and information that the user wants to look up out of the data the user inputted, and to use more conveniently the information, e.g., to insert such as graph or numerical expression or equation. Also, it is preferable for the screen forming tool to provide a function allowing the user to form several screens in a database.

In this screen, a form name ‘English, Math Average’ is inputted in the form name (510) (step S222). And, if selected a column (512) to display on the form, it is added to the form, and the form selected for preview is displayed (steps S224, S226). In the screen for preview (520), the user can change the position of a column added by drag-and-drop, or input the column name (522). And, it is possible to input a style (514) or a numerical expression (516) (steps S228, S230, S232). Then, the ‘English, Math Average’ user interface form is generated by pushing a generation button (518) (step S234). The generated user interface form is added to the form list of database (242) through a form manager (220) and a DB manager (230) (step S236), links the form information with the databases (530) which were generated before, and stores the form information that the user inputs in the database (242) (step S238).

The database template (that is, database file) includes the database information which the user generated and the data stored according to the structure of database which the user generated. If the user allows the database template to include the meta data information on the user interface form (user screen) generated by him/herself, the user can look up the information in a form that he/she wants. The database information that the user generated includes the name and the field list (field name, data type information, etc.) which the user inputted when generating the data (400). The user interface form information, that is, the meta data on the user screen, includes the form (user screen) name which the user inputted and the column (corresponding to ‘field’) list which the user selected to show on the user screen. And, each column information of the column list comprises list of column information such as column name, displaying style of column data which the user inputted for each field (e.g., if the specific column is of the date type, the user interface form generation wizard (500) allows the user to select displaying style such as, for example, ‘2008-11-19, ‘2008.11.19’, and ‘19^{th} Nov 2008, and handles meta data for representing the displaying style which the user selected), column position information (that is, displaying order for each field), and field ID corresponding to the column. Also, a specific meta data on the user interface form (user screen) may contain information on graph and/or numerical expression formed by using data of corresponding database.

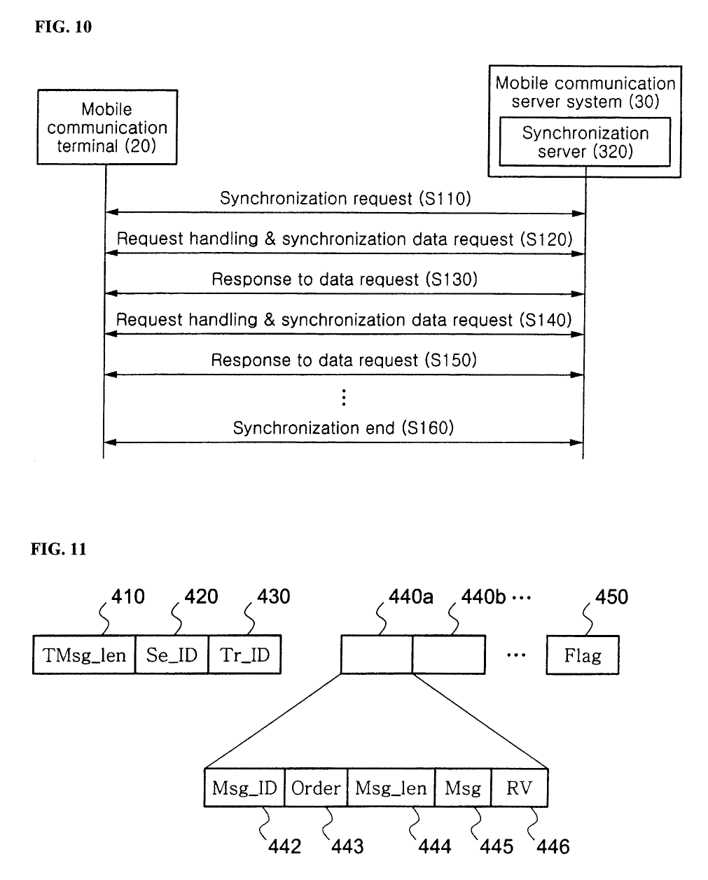

FIG. 10 is a flowchart illustrating flow between a template and a user data in a service provided on a web server (310). The database template provider (a general user or contents provider (CP)) makes a database template from specific contents (for example, automobile ledge, shopping list, recipe, customer manager, game item level, etc.), and registers it to the template list of databases (332) of a server DB system (330) through a web server (310). The mobile communication server system (30) enables the users to access the web server (310) and purchase the registered templates. The users can change the template which is allowed to purchase or use within the limiting scope which the contents provider allowed, that is, the using right in a style they want, and then use it.

In order to force the use within the allowed scope, the database template provider stores information on scope to allow editing, sharing, and copying of his/her own template along with the database templates. For example, the editing scope includes two status values, Read Only (RO) or Modify Available (MA). For each of database structure (DS), record (R) (data stored in the data structure), user interface (UI), scopes allowing ‘read’ or ‘write (modify)’ are assigned (that is, ‘read’ only or both of ‘read’ and ‘write’ can be allowed for a specific template). And, the scope allowing sharing and copying may comprise three status values, open to none (copying prohibited), open to a specific user (copying allowed for a specific user), and open to all (copying allowed to all).

Each status value is stored along with the database template, for example in a form of integer value. For example, when the allowed editing scope for a specific database template represents the RO and the MA as ‘0’ and ‘1’, respectively, the using right for the DS, R, and UI may be stored, for example, as DS=0, R=1, and UI=1. When such using rights are set for a specific database template and the user wants to manipulate the database template, the system limits the scope of the users' using the database template according to the set using right data. In the above example, since the allowed editing scope stored in the database template are ‘DS=0, R=1, UI=1’, the user cannot edit the database structure (DS), but can modify the record (R) and the user interface (UI). A trial to use beyond the allowed scope is not activated on a screen using the database template, such that the action beyond the allowed scope is controlled not to take place.

Also, the user can send or receive the template to other user within the scope which the template provider sets. Also, the user can register the user interface which the user him/herself generated as a template in the mobile communication server system (30). Especially, the user can set a sharing right for the template or the user interface which the user registered, and share them with other users through the web server. As for the sharing right, it is possible to assign, for example, ‘number of people to share’, or a ‘database owner (creator, manager, template purchaser) can specify a user whom they want to share with.

In a web server (310) of the mobile communication server system (30), a service corresponding to a method of dynamically managing data is provided in a same style as the general web service. The service functions supported by the web server (310) for a method of dynamically managing data comprise the followings. First, it is a ‘user database and template managing function.’ This function provides, in detail, i) a database and template (name and data type assignment) generating function, ii) viewing function such as data view for names the user selected, overview, view selection according to presence or absence of synchronization, and iii) data input function to database (input type corresponding to data type, setting of input limitations of maximum and minimum values). Second, they are additional functions on the user database and template. Exemplary additional functions comprise i) aligning function (ascending or descending order alignment of each data, etc.), ii) search functions (data search for selected name or type), iii) calculating function (operations such as summation, averaging, and etc. of selected data), and iv) functions for purchasing or selling of template, real-time data-providing paid service. Third, as it is a function of downloading and uploading the user database and template, which supports, for example, downloading and uploading to the personal computer (50) through the webpage using a standard file style, and supports downloading and uploading for the mobile communication terminal (20). Lastly, it is a function for sharing the user database and template. The function comprises, in detail, i) functions for sending or receiving the user database or template registered on the web, ii) function for setting owner, using rights, etc., and iii) functions for using in forms of message board, blog, mailing list, etc.

The synchronizing function uploads or downloads databases, between the mobile communication terminal (20) and the mobile communication server system (30), which the user generated for him/herself or templates which the provider provided, and makes contents of database stored in a specific user's mobile communication terminal (20) harmonious with contents of the user's database (332) stored in the server database system (330) of the mobile communication server system (30). Through this synchronizing function, the user can receive information he/she wants from the mobile communication server system (30) to the mobile communication terminal (20) in real-time, or reversely back up important information stored in the mobile communication terminal (20) into the mobile communication server system (30).

There exist various types of synchronizing databases between the synchronization server (320) of the mobile communication server system (30) and the mobile communication terminal (20). One way is to make the kinds of the databases in both of the mobile communication terminal (20) and the mobile communication server system (30) same, and then to make the data in each database same, in two steps. FIG. 10 is a diagram illustrating a signal processing chart showing synchronization process between a synchronization server (320) of the mobile communication server system (30) and the mobile communication terminal (20). Synchronizing starts when the mobile communication terminal (20) requests synchronization to the synchronizations server (320). For this, in the mobile communication terminal (20) a synchronization request message is formed complying the style, and then sent to the synchronization server (320), requesting the synchronization (step S110). The synchronization request message includes information such as ID and password of user registered in the synchronization server (320), database information for checking where there is any difference between both databases for synchronization, synchronizing time, transmissible maximum message size, etc.

The synchronization server (320) in waiting receives the synchronization request message, analyzes it, and then performs the synchronization (step S120). The synchronization server (320) performs different synchronizations according to whether it is a database which has never been synchronized after data generation in the mobile communication terminal (20), a database which has never been synchronized after data generation in the web server (310), or a database in which the data has been changed in the mobile communication terminal (20) or the mobile communication server system (30) after one or more synchronization. The reason for different synchronizations is for preventing exchange of unnecessary data and synchronizing precisely. For two databases which have been synchronized before, exchange of only the data modified after the previous synchronization is needed in the following synchronization. The synchronization of database which has never been synchronized is performed by exchanging all the data. Here, the synchronization message from the synchronization server (320) to the mobile communication server system (30) includes schema of database for synchronization and data added, modified, and deleted in the database.

The mobile communication terminal (20) performs processes according to the message which the synchronization server (320) sent, and sends a message responding to it to the synchronization server (320) of the mobile communication server system (30) (step S130). The synchronization server (320) analyzes the response message from the mobile communication terminal (20), writes synchronization data for the mobile communication terminal (30), and then sends the message to the mobile communication terminal (20) (step S140). The mobile communication terminal (20) stores the received message, and sends a message responding to it to the mobile communication server (step S150). The steps S140 and S150 are repeated until the synchronization is achieved normally or an error occurs. If the synchronization is performed normally, the synchronization server (320) sends a normal process ending message to the mobile communication terminal (20) and disconnects the connection (step S160). If, during the synchronization, a message malfunction, communication disturbance, exceeding of capacity acceptable to the mobile communication terminal (20), etc. occur, any one side of the mobile communication terminal (20) and the mobile communication server system (30) sends an error message to the other side. Then, all materials are returned (rollback) and the connection between the two sides is disconnected.

FIG. 12 shows details of an exemplary synchronization message. The synchronization server (310) sends the synchronization information fast and precisely by exchanging data through a synchronization protocol. The communication data is transmitted byte by byte, and a fast transmission is possible by reducing unnecessary message. The synchronization message comprises length of entire message (410), session ID (420), transaction ID (430), at least one message (440a, 440b, . . . ), and flag (450). And, each message (440a, 440b, . . . ) includes five items, that is message ID (442), order (443), message length (444), message (445), and return value (446). One session is an entire message from request of synchronization to the ending of process. And, one transaction is a step of transmitting a message once in a session. There can exist several messages in a transaction.

The length of entire message means a total length of the entire message to receive, and, for example, it may comprise numbers only, 6 bytes in total. The session ID (420) may comprise characters, for example, 8 bytes. The session ID is an ID set in a session, and one session may have a session ID. The session ID is determined in the server, and includes characters having specific rules. The transaction ID (430) means a number in the order of the transmitted transaction in a session, and, for example, comprises three bytes of number. The message ID (442) means a number in the order the message in a transaction, and, for example, comprises five bytes of number. The order (443) is used to distinguish the meaning of a message, in which a role of the message is mapped to a predetermined value in advance, and, for example, comprises three bytes of number. The length of message (444) means the length of the message to transmit, and, for example, comprises eight bytes of number. The message (445) means the information data (message) itself to be transmitted physically, and its length is variable. The return value (446) is used to analyze the results of the response message after the message transmission, and, for example, comprises four bytes of number. The flag (450) comprises, for example, one byte of character. The characters in the flag comprise ‘C’ and ‘E’. The letter ‘C’ means that it will retransmit the information continued in the following transaction, and the letter ‘E’ means that the message will end in the present message.

As disclosed in the above, the present invention enables the users to share their own data and manage dynamically using the mobile communication terminal (20), the mobile communication server system (30), and the personal computer (50). That is, the user of mobile communication terminal can form data he/she wants with structure arbitrarily, and input data. Also, the data managed in the mobile communication terminal can be stored and managed in a mobile communication server system (30) through a wireless network or one's own personal computer (50) through cable. Furthermore, the user is enabled to download a data managing template which a provider provides from the mobile communication server system (30) and use it conveniently, such that the user does not have to form a data managing structure for him/herself.

Even though explained with embodiments, one ordinarily skilled in the arts may modify or change the present invention without leaving the ideas and concepts of the present invention. Therefore, all the changes or modifications within the meanings and scopes equivalent to those of the present invention belong to what is claimed in the present invention.

What is claimed is:

1. A method of dynamically managing databases in a mobile communication terminal, the method comprising:
a first step of providing a user input screen to allow a user to generate a database of the user's own desirable structure in the mobile communication terminal, generating a dynamic database structure based on database generation information inputted by the user through the input screen, and storing the generated database structure and the database generation information inputted by the user in a first storing means of the mobile communication terminal, on the user's request;
a second step of providing an editing screen for editing a structure of a database which the user selects out of the databases stored in the first storing means, and changing the structure of the database stored in the first storing means and the database generation information based on editing operation that the user performs on the editing screen, on the user's request; and
a third step of, if the users upload the database templates written in advance by the users onto a mobile communication server system through a communication network using a mobile communication terminal or a personal computer, the mobile communication server system's receiving the uploaded database template, storing in a second storing means in the mobile communication server system, and registering the uploaded database template received as a sharable database template,
wherein the database template comprises a file including a name of the database generated with a pre-designed structure and information on the database such as data stored following the data structure of the database, or a file further including some additional data, and
wherein the database template is set with at least one of a sharing right and a using right.

2. The method of claim 1, further comprising a step of providing a screen forming tool for forming a desirable user screen in order to enable the user to select and observe data of a specific database in the first storing means or the second storing means in a desirable form, and storing a specific meta data on the user screen that the user formed as the additional data in the specific database.

3. The method of claim 2, wherein the database template desirably further comprises meta data on the user screen including a name of the user screen and a selected column list.

4. The method of claim 2, wherein the specific meta data on the user screen preferably comprises the name of the user screen and the column list that the user selected for displaying on the user screen, and each of the column information of the column list preferably comprises a column title, a style of column data that the user inputs, a column position information (that is, order of display on the screen for each field), and a field ID corresponding to the column.

5. The method of claim 2, wherein the specific meta data on the user screen comprises information on graphs and/or numerical expressions formed by using data of corresponding database.

6. The method of claim 1, wherein the database template comprises a meta data on the advertisement such as a separate table or column for inserting the advertisement thereinto as the additional data.

7. The method of claim 1, wherein the sharing right comprises information specifying a number of sharable users and/or the users for whom sharing is allowed for the database template.

8. The method of claim 1, wherein the using right comprises information specifying at least one among an allowed using action of using, an allowed editing scope, an allowed sharing scope, and an allowed copying scope for the database template.

9. The method of claim 1, wherein the database generation information which is inputted by the user in the first step comprises information on a name of database, a number of field of the database, a name of the field, and a data type of each field.

10. The method of claim 1, further comprising a step of the mobile communication server system's providing list of the database template stored in the second storing means to the mobile communication terminal on request from the user of the mobile communication terminal, and, if the information of database template which the user selected is received from the mobile communication terminal, reading out the selected database template from the second storing means, and transmitting to the mobile communication terminal of the user.

11. The method of claim 10, wherein the database template comprises in the database template only the data which is free from characteristics of platform of the mobile communication terminal, such that the shared database is used in a mobile communication terminal of different types irrespective of the platform characteristics of the mobile communication terminal.

12. The method of claim 1, further comprising a step of the mobile communication server system's maintaining the database list by the users, displaying on the web the contents of the database for a specific database which the user wants to look up or edit, and updating the specific database with the updated contents, wherein the database list comprises information on names of all databases that the user owns, times of generation of database, times of synchronization, and number of owned data.

13. The method of claim 1, further comprising steps of:
if the user requests synchronizing of a specific database stored in the first storing means, the mobile communication terminal's finding out a database for synchronizing that the user requested in the first storing means, delivering information for synchronizing to the mobile communication server system through a wireless communication network, and requesting synchronizing of the requested database; and
on answering the synchronization request of the mobile communication terminal, if the corresponding database does not exist in the second storing means, the mobile communication server system's generating the synchronization-requested database newly, and if the corresponding database exists in the second storing means, and updating the corresponding database into the synchronization-requested database to perform synchronizing such that the synchronization-requested database coexists with same contents in the mobile communication terminal and the mobile communication server system.

14. The method of claim 13, wherein the information for synchronizing comprises a synchronization request message including a users ID and password of a user registered in the mobile communication server system, a database information for checking whether there is a difference between the databases of the mobile communication terminal and the mobile communication server system, and a synchronizing time used for synchronizing, and a maximum message size information for transmitting.

15. The method of claim 14, wherein the synchronizing process performs synchronizing, based on analysis of the synchronization request message, i) in a way of exchanging all the data of the synchronization-requested database if the database has never been synchronized after data generation in the mobile communication terminal, ii) in another way of exchanging only the data updated in the synchronizing process if the database has been synchronized at least once.
